(19) United States
(12) Patent Application Publication
(10) Pub. No.: US 2010/0112309 A1
(43) Pub. Date: May 6, 2010

(54) Appearance Part of Electronic Device and Method for Manufacturing the Same

(75) Inventor: Chia Chang Liu, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Pegatron Corporation, Taipei (TW)

(21) Appl. No.: 12/603,815

(22) Filed: Oct. 22, 2009

(30) Foreign Application Priority Data
Oct. 31, 2008 (TW) 097142004

(51) Int. Cl. B32B 33/00; B29C 41/22

(52) U.S. Cl. 428/195.1; 264/73

(57) ABSTRACT

This invention provides an appearance part of an electronic device and a method for manufacturing the same. The appearance part of the electronic device is manufactured by processing a first plastic and a second plastic via a color-mixing molding process. The first plastic and the second plastic have a melt flow index and are polystyrene of different colors or different transparency. In this invention, the problem that the appearance part of the electronic device has a uniform color and long manufacturing time in the prior art is solved by controlling each of manufacturing conditions in the color-mixing molding process.

### CROSS-REFERENCE TO RELATED APPLICATIONS

This Non-provisional application claims priority under 35 U.S.C. §119(a) on Patent Application No(s). 0970142004 filed in Taiwan, Republic of China on Oct. 31, 2008, the entire contents of which are hereby incorporated by reference.

### BACKGROUND OF THE INVENTION

1. Field of the Invention

The invention relates to an appearance part of an electronic device and, more particularly, to an appearance part of an electronic device made of polystyrene and a method for manufacturing the same.

2. Description of the Related Art

With development of human material civilization, a method for manufacturing a product via a mold has become necessary technology in modern life. The method for manufacturing a product via a mold is divided into injection molding process, blow molding process, press forming process, foam molding process and so on. During the injection molding process, a material such as plastic is heated, and the molten material is then injected into a mold. The mold is separated and a product is taken away after the material injected into the mold is cooled.

The injection molding process spends short manufacturing time and less money; and further, the injection molding process can manufacture products with complex shapes. so that it has a gradually widened application range. In general, a conventional appearance part of an electronic device is mostly made of plastic, and the injection molding technology is often used to manufacture the same.

With the development of consuming electronic devices, functions and applications have more and more variety, and therefore how to attract consumers to buy the consuming electronic devices is a considerable problem. According to the aforementioned, an appearance design of the consuming electronic devices becomes an important factor. However, if an appearance part of an electronic device formed by injection molding process does not have additional painting or coloring, basically the electronic device only presents a uniform color of the plastic itself, which appears dull and fails to satisfy the present needs about the appearance part of the electronic device.

In a subsequent development, a plastic injection product of a certain color is obtained by mixing plastic and color materials before the injection molding process. Otherwise, a molding machine with two injection devices is used to inject plastic of two colors or different types of plastic. However, the above methods resulted in increasing manufacturing time; and further, the product has a clear color without mixture, which fails to provide varied appearances.

### BRIEF SUMMARY OF THE INVENTION

This invention provides an appearance part of an electronic device manufactured by processing first plastic and second plastic via a color-mixing molding process. The first plastic and the second plastic have a melt flow index. The first plastic and the second plastic are polystyrene of different colors or different transparency. In one embodiment of the invention, the appearance part of the electronic device may be a casing of an electronic device or a skin for decorating an appearance of an electronic device.

In addition, the invention further provides a method for manufacturing an appearance part of an electronic device, and the method is performed in a color-mixing molding device. The method includes the following steps. First, a first plastic and a second plastic are provided. The first plastic and the second plastic are polystyrene of different colors. The first plastic and the second plastic are then injected into the color-mixing molding device. A color-mixing molding process is performed for the first plastic and the second plastic in the color-mixing molding device. The first plastic and the second plastic are ejected into a mold via a gate of the mold to form the appearance part of the electronic device.

In this invention, polystyrene of two different colors is used as materials of the color-mixing molding process. By controlling the manufacturing conditions of the color-mixing molding process, such as a melt flow index of the two kinds of the plastic and pressure exerted on the two kinds of the plastic and so on, in cooperation with the location of the gate of the mold, the appearance part of the electronic device having different decorative patterns can be manufactured, thus to solve the problem of the uniform color and the long manufacturing time in the prior art.

These and other features, aspects, and advantages of the present invention will become better understood with regard to the following description, appended claims, and accompanying drawings.

### BRIEF DESCRIPTION OF THE DRAWINGS

FIG. 1A is a first schematic diagram showing an appearance part of an electronic device according to one preferred embodiment of the invention;

FIG. 1B is a second schematic diagram showing an appearance part of an electronic device according to one preferred embodiment of the invention;

FIG. 1C is a third schematic diagram showing an appearance part of an electronic device according to one preferred embodiment of the invention;

FIG. 1D is a fourth schematic diagram showing an appearance part of an electronic device according to one preferred embodiment of the invention;

FIG. 2A is a flow chart showing a method for manufacturing an appearance part of an electronic device according to one preferred embodiment of the invention;

FIG. 2B is a flow chart showing a color-mixing molding process according to one preferred embodiment of the invention;

FIG. 3A is a schematic diagram showing a color-mixing molding device according to one preferred embodiment of the invention; and

FIG. 3B is a sectional schematic diagram showing a pipe of a color-mixing molding device.

### DETAILED DESCRIPTION OF THE INVENTION

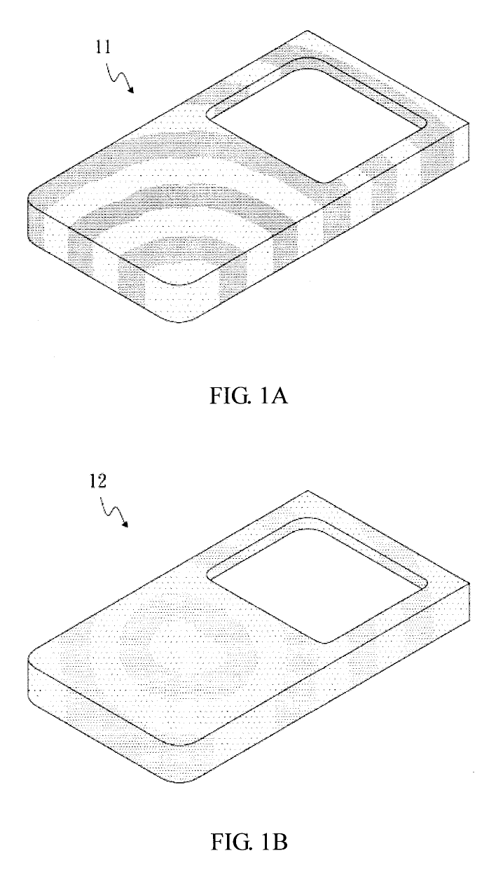

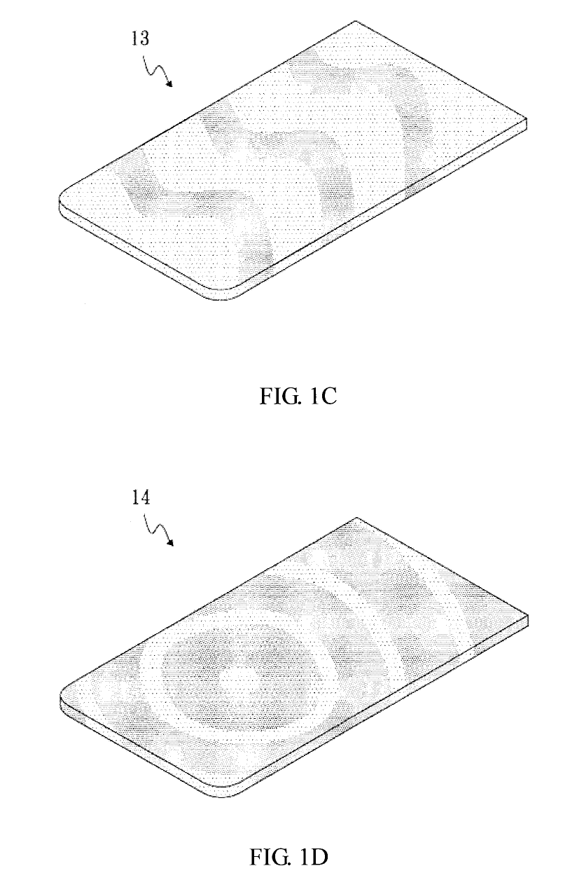

FIGS. 1A to 1D are first to fourth schematic diagrams showing an appearance part of an electronic device according to one preferred embodiment of the invention, respectively. Please refer to FIGS. 1A to 1D, qn appearance part of an electronic device is manufactured by processing a first plastic and a second plastic via a color-mixing molding process. The first plastic and the second plastic are polystyrene of different colors or different transparency. In one preferred embodiment, the polystyrene may be GPPS or HIPS.

In this embodiment of the invention, the appearance part of the electronic device may be a casing of an electronic device, a skin for decorating an appearance of an electronic device, or a decoration at a side edge of an electronic device and so on. However, the invention is not limited thereto. The appearance parts 11, 12 of the electronic device are casings as FIG. 1A and FIG. 1B. The appearance parts 13, 14 of the electronic device are skins as FIG. 1C and FIG. 1D. In one embodiment of the invention, the appearance part of the electronic device has a grain pattern.

In one embodiment of the invention, a temperature of the first plastic and the second plastic for manufacturing the appearance part of the electronic device in a color-mixing molding process is between 170° C. and 185° C.; And further, a melt flow index of the first plastic and the second plastic is about between 0.8 g/min and 1.5 g/min under the above temperature.

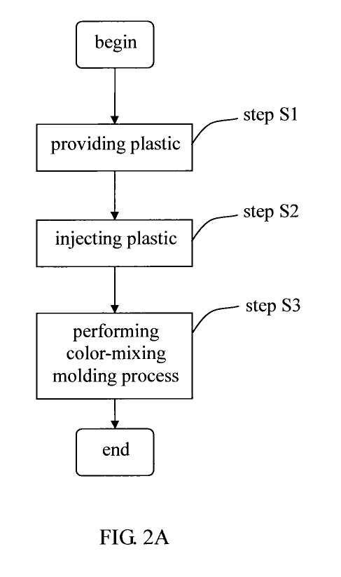

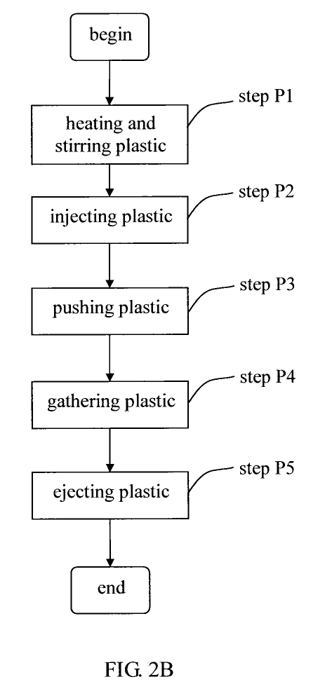

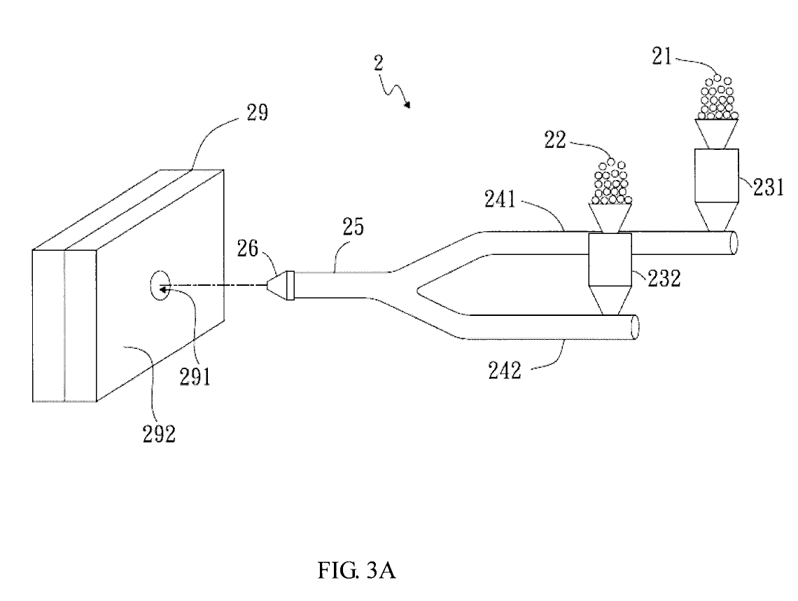

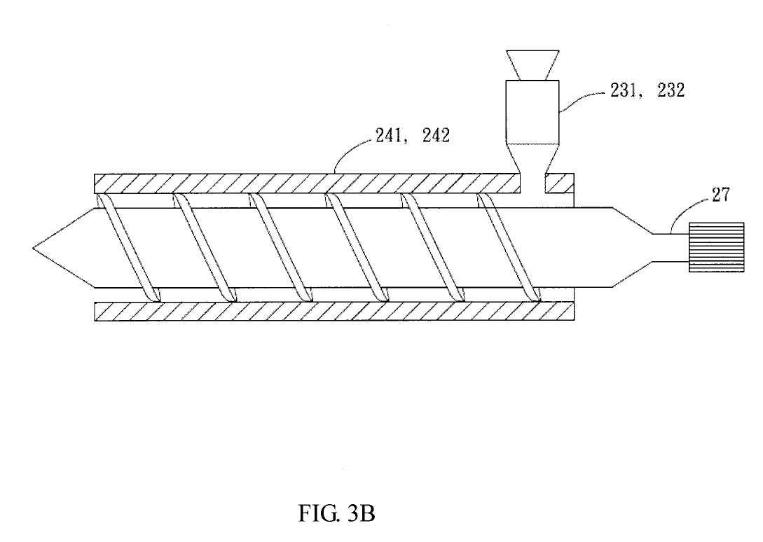

Please refer to FIGS. 2A to 3B. According to the embodiment of the invention, the appearance part of the electronic device is manufactured by processing the first plastic and the second plastic via a color-mixing molding device. The manufacturing flow paths are further described hereinbelow. FIG. 2A is a flow chart showing a method for manufacturing an appearance part of an electronic device according to one preferred embodiment of the invention. FIG. 2B is a flow chart showing a color-mixing molding process according to one preferred embodiment of the invention. FIG. 3A is a schematic diagram showing a color-mixing molding device according to one preferred embodiment of the invention. FIG. 3B is a sectional schematic diagram showing a pipe of the color-mixing molding device.

Please refer to FIG. 2A, the method for manufacturing an appearance part of an electronic device includes the following steps.

Step S1: providing plastic.

A plastic 21 and a second plastic 22 are provided. The first plastic 21 and the second plastic 22 are polystyrene of different colors or different transparency.

Step S2: injecting the plastic.

The first plastic 21 and the second plastic 22 are then injected into a color-mixing molding device 2, respectively.

Step S3: performing a color-mixing molding process.

In addition, please refer to FIG. 2B and FIG. 3A, the color-mixing molding device 2 includes two heating stirrers 231, 232, two pipes 241, 242, a nozzle 26, and a barrel 25 connecting the pipes 241, 242 and the nozzle 26. The color-mixing molding process as shown in FIG. 2B includes the following steps.

Step P1: heating and stirring the plastic.

The heating stirrers 231, 232 are used to heat and stir the first plastic 21 and the second plastic 22, respectively, to allow the temperature thereof to be between 170° C. and 185° C.

Step P2: injecting the plastic.

A melt flow index of the first plastic 21 and the second plastic 22 is about between 0.8 g/min and 1.5 g/min after step P1. The first plastic 21 and the second plastic 22 are then injected into the pipe 241 and the pipe 242, respectively.

Step P3: pushing the plastic.

Please refer to FIG. 3B, screws 27 are disposed in the pipe 241 and the pipe 242, respectively. Pressure is exerted on the first plastic 21 and the second plastic 22 via rotation of the screws 27, respectively, to push them to flow toward the barrel 25. In one preferred embodiment, the pressure exerted on the first plastic 21 is between 45 kg/cm² and 65 kg/cm², and the pressure exerted on the second plastic 22 is between 45 kg/cm² and 65 kg/cm². In addition, a flow speed of the first plastic 21 in the pipe 241 is between 50 cm²/sec and 70 cm²/sec, and a flow speed of the second plastic 22 in the pipe 242 is between 45 cm²/sec and 65 cm²/sec.

In the pushing step, the pressure and the flow speed may vary with a mold cavity design of the mold. The method for manufacturing an appearance part of an electronic device in this invention is not limited thereto.

Step P4: converging the plastic.

The first plastic 21 and the second plastic 22 are converged in the barrel 25. The first plastic 21 and the second plastic 22 in the barrel 25 do not merge with each other since the melt flow index of the polystyrene is between 0.8 g/min and 1.5 g/min; and further, they only generate little interactive diffusion at the contacting surface so that the first plastic and the second plastic located in the barrel 25 have clear gradation and a gradually layered effect at their boundary.

Step P5: ejecting the plastic.

The first plastic 21 and the second plastic 22 are ejected via the nozzle 26 and ejected into a mold 29 via a gate 291 of the mold 29 to form an appearance part of an electronic device.

In the ejecting step, if the gate 291 is disposed at a center of a surface 292 of the mold 29, the formed appearance part of the electronic device may have a grain pattern with two alternative colors, and the boundary of the two colors also has a gradually layered effect. However, the grain pattern is just one example. That is, by changing the location of the gate 291 at the surface 292 or intermittently ejecting at least one of the first plastic 21 and the second plastic 22 into the mold 29, the appearance part of the electronic device can have different decorative patterns.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An appearance part of an electronic device manufactured by processing a first plastic and a second plastic via a color-mixing molding process, wherein the first plastic and the second plastic have a melt flow index and are polystyrene of different colors.

2. The appearance part of an electronic device according to claim 1, wherein the appearance part of the electronic device is a casing.

3. The appearance part of an electronic device according to claim 1, wherein the appearance part of the electronic device is a skin.

4. The appearance part of an electronic device according to claim 1, wherein the polystyrene is GPPS or HIPS.

5. The appearance part of an electronic device according to claim 1, wherein the appearance part has a grain pattern formed by arranging the first plastic and the second plastic alternately.

6. The appearance part of an electronic device according to claim 1, wherein a temperature of the first plastic and the second plastic during the color-mixing molding process is between 170° C. and 185° C. .

7. The appearance part of an electronic device according to claim 6, wherein the melt flow index of the first plastic and the second plastic is between 0.8 g/min and 1.5 g/min.

8. The appearance part of an electronic device according to claim 1, wherein transparency of the first plastic is different from that of the second plastic.

9. A method for manufacturing an appearance part of an electronic device, the method performed in a color-mixing molding device, the method comprising the following steps of:
providing a first plastic and a second plastic, the first plastic and the second plastic being polystyrene of different colors;
injecting the first plastic and the second plastic into the color-mixing molding device; and
performing a color-mixing molding process to allow the first plastic and the second plastic to be ejected into a mold via a gate of the mold.

10. The method for manufacturing an appearance part of an electronic device according to claim 9, the color-mixing molding device including at least two pipes, a nozzle, and a barrel connecting the pipes and the nozzle, wherein the color-mixing molding process comprises the following steps of:
heating the first plastic and the second plastic;
injecting the first plastic and the second plastic into the pipes respectively;
pushing the first plastic and the second plastic in the pipes to flow toward the barrel;
converging the first plastic and the second plastic in the barrel; and
ejecting the first plastic and the second plastic from the nozzle.

11. The method for manufacturing an appearance part of an electronic device according to claim 10, wherein after the heating step, a temperature of the first plastic and the second plastic is between 170° C. and 185° C.

12. The method for manufacturing an appearance part of an electronic device according to claim 10, wherein after the heating step, a melt flow index of the first plastic and the second plastic is between 0.8 g/min and 1.5 g/min.

13. The method for manufacturing an appearance part of an electronic device according to claim 10, wherein in the pushing step, a pressure exerted on the first plastic is between 45 kg/cm² and 65 kg/cm².

14. The method for manufacturing an appearance part of an electronic device according to claim 10, wherein in the pushing step, a pressure exerted on the second plastic is between 45 kg/cm² and 65 kg/cm².

15. The method for manufacturing an appearance part of an electronic device according to claim 10, wherein in the pushing step, a flow speed of the first plastic is between 50 cm²/sec and 70 cm²/sec.

16. The method for manufacturing an appearance part of an electronic device according to claim 10, wherein in the pushing step, a flow speed of the second plastic is between 45 cm²/sec and 65 cm²/sec.

17. The method for manufacturing an appearance part of an electronic device according to claim 9, wherein in the step of ejecting the first plastic and the second plastic into the mold, at least one of the first plastic and the second plastic is ejected intermittently.

18. The method for manufacturing an appearance part of an electronic device according to claim 9, wherein the gate of the mold is located at a center of a surface of the mold.

19. The method for manufacturing an appearance part of an electronic device according to claim 18, wherein the appearance part of the electronic device has a grain pattern formed by arranging the first plastic and the second plastic alternately.

20. The method for manufacturing an appearance part of an electronic device according to claim 9, wherein the polystyrene is GPPS or HIPS.

21. The method for manufacturing an appearance part of an electronic device according to claim 9, wherein transparency of the first plastic is different from that of the second plastic.

22. The method for manufacturing an appearance part of an electronic device according to claim 9, wherein the appearance part of the electronic device is a casing.

23. The method for manufacturing an appearance part of an electronic device according to claim 9, wherein the appearance part of the electronic device is a skin.
